(19) United States
(12) Patent Application Publication
(10) Pub. No.: US 2012/0310955 A1
(43) Pub. Date: Dec. 6, 2012

(54) Identifying Languages Missing From Campaigns

(75) Inventors: Jakob Uszkoreit, San Francisco, CA (US); Jeffrey Chin, Sugar Land, TX (US); Lucia Poncela, Ashbourne (IE); Nicolas De Kermadec, San Francisco, CA (US)

(73) Assignee: Google Inc., Mountain View, CA (US)

(21) Appl. No.: 13/216,032

(22) Filed: Aug. 23, 2011

Related U.S. Application Data
(60) Provisional application No. 61/492,600, filed on Jun. 2, 2011.

(51) Int. Cl. G06F 17/30

(52) U.S. Cl. 707/754; 707/E17.13

(57) ABSTRACT

A technique includes determining whether a first webpage includes content in a first language, where the first webpage is a landing page associated with an advertising campaign of a content sponsor, determining whether a second webpage includes the content in a different second language where the second webpage is not a landing page in the advertising campaign, evaluating one or more criteria in order to make a recommendation for expanding the advertising campaign to include the second webpage, identifying a recommendation for expanding the advertising campaign to include the second webpage based at least in part on the evaluating.

### CROSS-REFERENCE TO RELATED APPLICATIONS

This application claims priority to Provisional Application No. 61/492,600, filed on Jun. 2, 2011, the entire contents of which is incorporated herein by reference.

### BACKGROUND

This specification relates to information presentation.

The Internet provides access to a wide variety of resources. For example, video and/or audio files, as well as web pages for particular subjects or particular news articles are accessible over the Internet. Access to these resources presents opportunities for content to be provided with the resources. For example, a web page can include advertisement slots defined in the web page or for presentation with a web page, in which advertisements can be presented. In some cases, advertisers provide their resources across multiple languages, but do not have an advertising campaign associated with the resources for each individual language.

### SUMMARY

This specification describes technologies relating identifying languages missing from advertising campaigns.

In general, one aspect of the subject matter described in this specification can be embodied in a technique, in which the technique encompasses determining a first webpage that includes content in a first language where the first webpage is a landing page associated with an advertising campaign of a content sponsor, determining a second webpage that includes the content in a different second language where the second webpage is not a landing page in the advertising campaign, evaluating, using one or more processors, one or more criteria in order to make a recommendation for expanding the advertising campaign to include the second webpage, and identifying a recommendation for expanding the advertising campaign to include the second webpage based at least in part on the evaluating.

In another aspect, a tool includes one or more processors and memory that are configured to interact to perform operations including: determining a first webpage that includes content in a first language where the first webpage is a landing page associated with an advertising campaign of a content sponsor, determining a second webpage that includes the content in a different second language where the second webpage is not a landing page in the advertising campaign, evaluating, using one or more processors, one or more criteria in order to make a recommendation for expanding the advertising campaign to include the second webpage, and identifying a recommendation for expanding the advertising campaign to include the second webpage based at least in part on the evaluating.

In another aspect, the subject matter described in this specification relates to instructions, encoded on a computer-readable medium, in which the instructions, when executed, cause data processing apparatus to perform operations including: determining a first webpage that includes content in a first language where the first webpage is a landing page associated with an advertising campaign of a content sponsor, determining a second webpage that includes the content in a different second language where the second webpage is not a landing page in the advertising campaign, evaluating, using one or more processors, one or more criteria in order to make a recommendation for expanding the advertising campaign to include the second webpage, and identifying a recommendation for expanding the advertising campaign to include the second webpage based at least in part on the evaluating.

These and other embodiments can optionally include one or more of the following features. For example, the criteria are selected from a group consisting of criteria related to a performance of the first webpage or the performance of the advertising campaign.

In some implementations, determining the first and second webpages includes identifying a translated document pair. Each translated document pair can include a first document containing the content in one language and a second document containing the content in a different language. Identifying the translated document pair can include filtering a collection of translated documents based on the content to provide the translated document pair. Alternatively, or in addition, filtering the collection of translated documents can be further based on one or more domains associated with the content. Alternatively, or in addition, filtering the collection of translated document pairs can be further based on a level of spending by an entity on advertising the content. Alternatively, or in addition, filtering the collection of translated document pairs can be based on user interaction data associated with the content.

In some implementations, identifying the translated document pair can include filtering a collection of translated document pairs based on a customer identification associated with the content sponsor to provide the translated document pair. Alternatively or in addition, identifying the translated document pair includes filtering a collection of translated document pairs can be based on one or more domains associated with the content sponsor to provide the translated document pair. The one or more domains can include one or more URLs associated with the content sponsor.

In another aspect, a technique includes determining a first content item that includes content in a first language where the content item includes a landing page associated with an entity, determining a second different content item that includes the content in a different second language where the second content item does not include a landing page associated with the entity, evaluating one or more criteria in order to make a recommendation to include the second different content item as a landing page, and identifying a recommendation to include the second different content item based on the evaluating.

In another aspect, the subject matter described in this specification relates to a computer-implemented technique that includes receiving a collection of webpage pairs, each pair including a first webpage containing common content in a first language and including a second webpage containing the common content in a second different language, at least one webpage in each pair corresponding to a translation from a source webpage, filtering the collection of webpage pairs to identify one or more pairs associated with a content sponsor, determining that a first webpage in an identified pair is a landing page for an advertisement associated with an advertising campaign of the content sponsor, determining that a second webpage in the identified pair is not a landing page in the advertising campaign, evaluating one or more criteria in order to make a recommendation for expanding the advertising campaign to include the second webpage, and providing the recommendation for expanding the advertising campaign to include the second webpage based at least in part on the evaluating.

In some implementations, evaluating one or more criteria includes evaluating a performance of the first webpage.

In some implementations, evaluating one or more criteria includes evaluating a performance of the advertising campaign.

In some implementations, evaluating one or more criteria includes evaluating a quantity of translated webpages associated with the content sponsor.

In some implementations, evaluating one or more criteria includes evaluating a level of advertising financing activity associated with the content sponsor.

In some implementations, determining that a second different webpage in the identified pair is not a landing page in the advertising campaign includes cross-checking an address of the second webpage with addresses of webpage links incorporated into one or more advertisements of the advertising campaign or cross-checking the second webpage with a website that contains landing pages associated with the advertising campaign.

The details of one or more embodiments are set forth in the accompanying drawings and the description below. Other features and advantages will be apparent from the description, the drawings, and from the claims.

### BRIEF DESCRIPTION OF DRAWINGS

FIG. 1A is a block diagram of an example environment 100 in which an advertisement management tool manages advertising services.

FIG. 1B is a block diagram of example web page.

FIG. 2 is a flow chart of an example routine 200 for identifying languages in which an advertiser does not currently advertise.

FIG. 3 is a flow chart of an example routine 300 for identifying web pages that contain the same content.

FIG. 4 is a diagram of an example computer tool.

### DETAILED DESCRIPTION

In general, one aspect of the subject matter described in this specification relates to computer-implemented techniques of identifying online content for which it may be desirable to expand a content (e.g., advertising) campaign into one or more different languages. The techniques disclosed can include, for example, obtaining or providing a collection of translated pairs of web pages and, from that collection, identifying a number of translated web pages associated with a particular content sponsor (e.g., advertiser) as well as the languages in which those web pages are translated. The translated web pages then are cross-referenced against websites that host landing pages for content campaigns. Based on results from cross-referencing, one or more languages are identified in which the content sponsor is not currently participating. A proposal then may be provided to the content sponsor to provide content in the one or more identified languages.

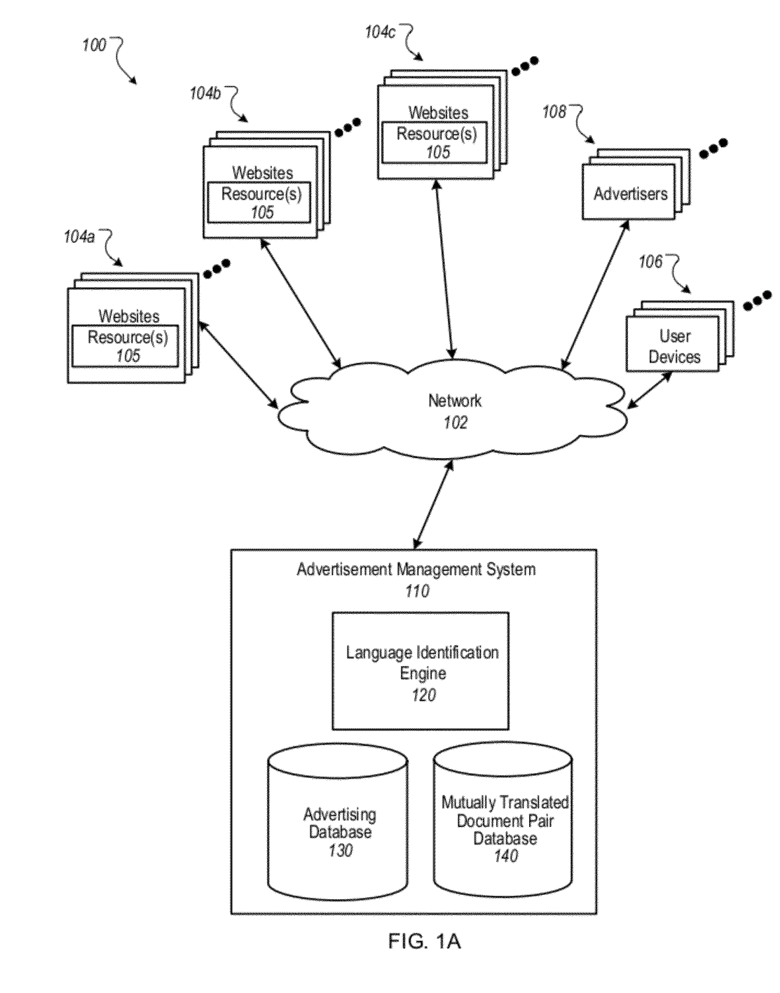

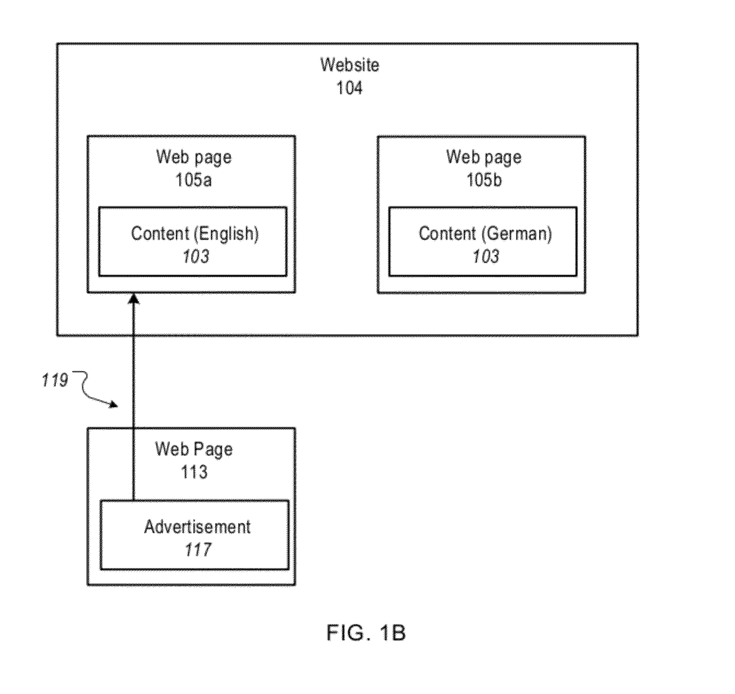

FIG. 1 is a block diagram of an example environment 100 in which a content management tool 110 (e.g., an internet advertisement management tool) manages content delivery services. The environment 100 includes a network 102, such as a local area network (LAN), a wide area network (WAN), the Internet, or a combination thereof The network 102 connects websites 104a-140c, devices 106, content management tool 110, and advertisers 108. Content management tool 110 includes language identification engine 120, content database 130, and mutually translated document pair database 140. Although shown as part of a single tool 110, each of the language identification engine 120, content database 130, and mutually translated document pair database 140 can include a data processing apparatus that is a separate standalone tool.

A website 104 can include one or more resources 105 associated with a domain name and hosted by one or more servers. An example website can include a collection of web pages formatted in hypertext markup language (HTML) that contains text, images, multimedia content, and/or programming elements, such as scripts. Each website 104a-104c can be maintained by a publisher/content provider, which includes an entity that controls, manages and/or owns the corresponding website 104.

A resource 105 includes any suitable data that can be provided over the network 102. A resource 105 is identified by a resource address that is associated with the resource 105. Resources include web pages, such as HTML pages, word processing documents, and portable document format (PDF) documents, images, video and feed sources, among others. The resources can include content, such as words, phrases, images and sounds, that may include embedded information (such as meta-information in hyperlinks) and/or embedded instructions (such as JavaScript scripts).

A user device 106 includes an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102 and for viewing and interacting with web resources 105.

A user device can request resources 105 from a website 104. In turn, data representing the resource 105 can be provided to the user device 106 for presentation by the user device 106. The data representing resource 105 can also include data specifying a portion of the resource or a portion of a user display (e.g., a presentation of a pop-up window or in a slot of a web page) in which content (e.g., advertisements) can be presented. Alternatively, or in addition, the resources 105 can include web pages that are landing pages for an advertisement.

A landing page includes a web page that appears when a potential customer, operating a user device 106, selects an advertisement in a separate referring resource 105, such as a web page or pop-up window, in the separate referring resource 105. The advertisement can be selected, for example, by clicking on an advertising link displaying text or an image. The landing page will usually display additional information, such as text or images, which is relevant to a particular product or service identified in the advertising link. For example, a user selection of an advertisement can initiate a request for presentation of a web page that is provided by (or for) the content sponsor 108. In some implementations, the landing page can include options that allow a potential customer to enter purchasing information, such as contact information or credit card information, which allows the customer to place a purchase order for the particular product or service or to request additional information. The landing page can be located on the same domain or a different domain as the referring web page.

The content (e.g. advertisements) included in the referring resource 105 are selected and placed in the resource 105, such as a webpage, by content management tool 110. The content can be selected based on characteristics of the resource 105 and/or based on information included in a request for content that is received by the content management tool 110. For example, content management tool 110 can select and place eligible advertisements in a webpage if the advertisement has characteristics matching the characteristics of advertisement slots in a website. Such characteristics can include, for example, keywords and site targeted advertisement campaigns.

The content management tool 110 can select and place content in a web page or other resource 105. In some implementations, the content is placed in response to a search query. For example, when a user submits, through the user device 106, a search query to a search tool (not shown), the search query can be accompanied by a request for additional content (e.g., an advertisement) to be provided with the search results or with a resource 105 obtained in response to the query. The request for additional content can include characteristics of the slots that are defined for the requested resource or search results page. An example of such characteristics includes key words included in the search query that can be used to facilitate identification of content that are relevant to the resource or search query. Content management tool 110 then selects content having characteristics matching the characteristics of the slots and identified as relevant to the specified resource keywords or search query and presents those selected content items to the user through the resource 105 or web page that displays the search results.

Content (e.g., advertisements) can be provided over the network 102 to the content management tool 110 by content sponsors 108 (e.g., advertisers). A content sponsor includes, among other things, any person, group of persons or business that seeks to market, sell, or advertise content, such as products for sale or consumption. In some implementations, content sponsors 108 submit to the content management tool 110 campaign parameters (e.g., targeting keywords and corresponding bids) that are used to control the distribution and placement of content in one or more resources 105. Campaign parameters are parameters of a content distribution campaign that are used to control content distribution in response to content requests and/or search queries. For example, campaign parameters can include targeting keywords and corresponding bids, geographic, psychographic or demographic targeting criteria, linguistic targeting, as well as other parameters corresponding to a set of content items.

A campaign can include a set of one or more content items and corresponding campaign parameters that are grouped together into a same unit. For example, content such as advertisements for sporting equipment can be grouped together into a campaign. Within a campaign, subsets of the content items can be grouped into “ad groups.” For example, an ad group in the above-referenced sports equipment campaign can include a set of advertisements for baseball equipment. In some implementations, content sponsors 108 can access the content management tool 110 to monitor performance of the content items that are distributed by the content management tool. For example, a content sponsor can access campaign performance reports that identify how many times a content item, such as an advertisement, has been presented in a resource 105 (e.g., impressions), how many times a user has interacted with the content item (e.g., clicks), and how many times the desired transaction (e.g., a sale of a product identified in an advertisement) occurs subsequent to a selection (e.g., conversion).

Information regarding each content sponsor 108 can be stored in the content database 130. For example, each content sponsor 108 may be associated with separate customer identification (ID). The client ID then can be associated with one or more campaigns. In some implementations, a content sponsor 108 makes payments to the content management tool 110 in exchange for placement of content by the content management tool. The payment information, such as amount, frequency, and the details of each content request, also can be stored in the content database 130. Other information about the sponsors including, but not limited to, the name, contact information, web addresses, number of campaigns, and campaign parameters associated with the campaigns also can be stored in the content database 130.

In some implementations, content sponsors 108 conduct business and/or offer web pages in more than one language. In some implementations, a content sponsor 108 may publish multiple websites 104a-104c, where each website pertains to the sponsor's business and includes web pages in a different corresponding language. For example, website 104a can include web pages where resources 105, such as text, are presented in the German language. In contrast, websites 104b and 104c can include web pages that present resources 105 in the Mandarin Chinese and English languages, respectively. Each of the websites 104a-104c can be associated with a particular sponsor on a same domain or on a different domain. Alternatively, or in addition, an individual website can include web pages in multiple languages as opposed to a single language.

In some implementations, the content sponsor 108 establishes a campaign for at least one of the websites 104a-104c or for one or more web pages in at least one of the websites 104a-104c. That is, a content sponsor 108 prepares a set of content items and corresponding campaign parameters that pertain to one or more websites or one or more web pages within a website, and provides the content and/or campaign parameters to the content management tool 110. The content management tool 110 then incorporates either the content item provided by the sponsor or a link into other web pages or resources 105 based on the campaign parameters. When a user selects the presented content item, for example by clicking on a link associated with an advertisement, the user is redirected (107) to a landing page where the landing page corresponds to a web page hosted by one of the websites 104a-104c.

In some implementations, however, the content sponsor 108 offers web pages and or websites in multiple different languages while advertising only in a subset of those languages. For example, FIG. 1B is a schematic of an example website 104 maintained by a content provider, where the website 104 includes web page 105a in which content 103 (e.g., text, images, video, audio) is presented in a first language (English). The website 104 also includes a second web page 105b that includes identical content as in web page 105a, except that the content 103 is now presented in a second different language (German). The first web page 105a serves as a landing page in an advertising campaign. That is, a third web page 113, which may or may not be located on website 104, includes an advertisement 117 that, when selected by a user (e.g., by clicking on the advertisement 117), re-directs (119) the user back to web page 105a. Such re-direction can include, for example, opening a new window in the user's Internet browser that displays the web page 105a or, alternatively, changing the web page currently displayed by the user's Internet browser. In contrast, the web page 105b does not serve as a landing page in an advertising campaign, e.g., there are no advertisements or links in other web pages that re-direct a user's browser to web page 105b. Without advertisements re-directing users to the web page 105b, the content provider may lose out on opportunities to market the content 103 to an audience that consumes information in the second language.

To expand a content provider's business and/or exposure, it therefore may be desirable to identify those languages in which the content sponsor is conducting business but in which the content sponsor is not currently advertising or does not have an advertisement campaign established. Once the languages in which the sponsor is conducting business but not advertising are identified, the content sponsor 108 can then make a decision as to whether to expand their content (e.g., advertising) into the additional languages by expanding an existing campaign to include the identified language or by creating a brand new campaign targeting the identified language. For example, referring to FIG. 1B, the web page 105a, which presents content 103 in English, may be a part of an advertising campaign, whereas the web page 105b, which presents the same content 103 in German, is not part of an advertising campaign. Accordingly, the German language can be identified to the content sponsor as a language in which the content sponsor may wish to expand a pre-existing advertising campaign. Alternatively, or in addition, the language may be identified to the content sponsor as a suggested language for a new advertising campaign.

One possible approach is to identify the number of languages present on a content sponsor's (e.g., advertiser's) website. Although this approach can be used to identify the number of languages for a particular website, the approach is unable to determine correctly in which of those languages the sponsor is marketing their business. For example, an advertiser may host websites on multiple domains (e.g., example_domain.com, example_domain.de, example_domain.co.kr). In addition, the identification of multiple languages on a website may not be a strong indicator of business activity. Accordingly, such identification does not provide additional information to the sponsor that can be used to determine whether to expand or establish an advertising campaign into other languages.

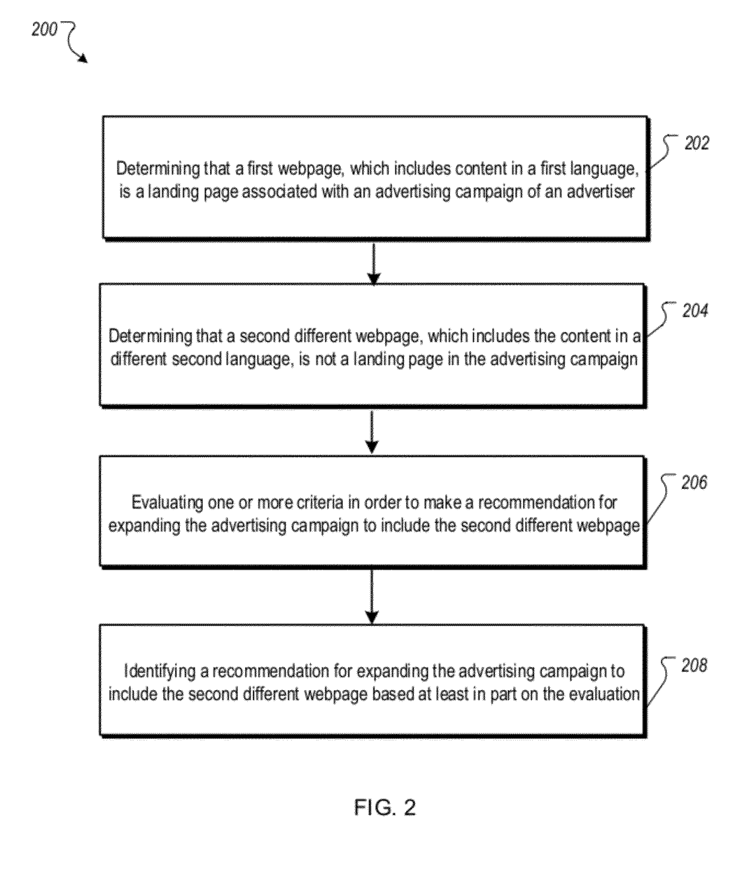

FIG. 2 is a flow chart of an example routine 200 for identifying languages in which a content sponsor, such as an advertiser or business, does not currently promote its content. The information obtained in the routine 200 can be used to provide the publisher or manager of a website a recommendation on whether to expand the content of the website into additional languages and/or to establish additional advertising links to web pages within the website. For example, the routine can be used to provide a recommendation to an advertiser or business on whether to expand/establish an advertising campaign into languages in which the advertiser/business is not currently advertising. Although the routine 200 is described below with reference to advertising content from a website, the routine 200 can also be used for other language identification purposes.

The routine 200 can be implemented, for example, by the content management tool 110 of FIG. 1. In some implementations, the content management tool 110 is a data processing apparatus that includes one or more processors that are configured to perform actions of the routine 200. In some implementations, a computer readable medium can include instructions that, when executed by a computer, cause the computer to perform the actions of the routine 200.

The routine 200 includes determining a first webpage that includes content in a first language where the first webpage includes a landing page associated with a campaign of a content sponsor (202). Examples of content can include text, word processing documents, portable document format (PDF) documents, images, video, and feed sources. The routine 200 further includes determining a second different webpage that includes the content in a different second language where the second webpage is not a landing page in the campaign (204). One or more criteria are evaluated in order to make a recommendation for expanding the campaign to include the second different webpage (206). A recommendation is identified for expanding the campaign to include the second different webpage based at least in part on the evaluation (208). Expanding the campaign can include, for example, including the address of the second different web page as a link in an advertisement such that the second different web page becomes a landing page associated with an advertising campaign.

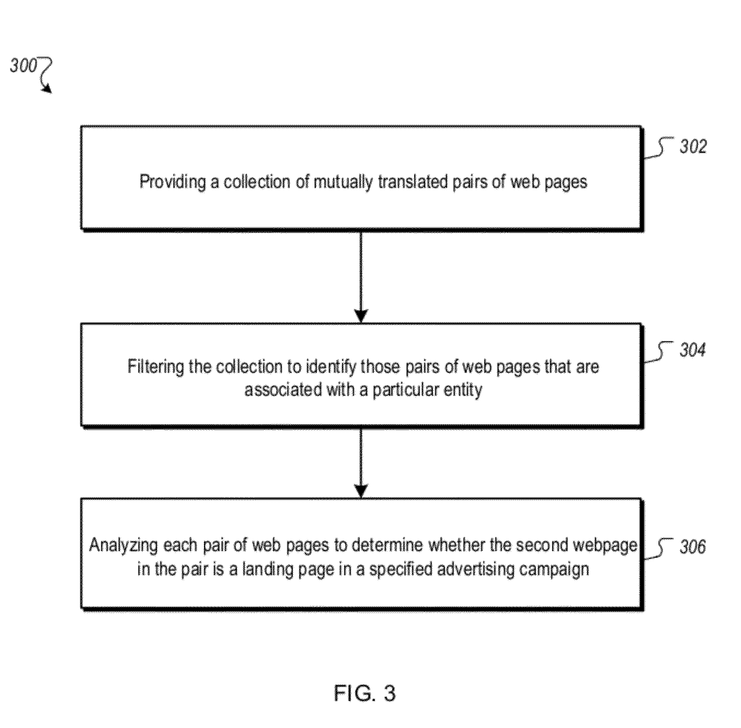

Identifying a first web page that includes content in a first language and a second web page that includes the content in a different second language includes, for example, identifying pairs of mutually translated web pages that are associated with a particular entity, such as an advertiser. FIG. 3 is a flow chart of an example routine of identifying web pages that contain the same content, where the content is presented in a different corresponding language on each respective page. The routine 300 can be implemented, for example, by the language identification engine 120 of FIG. 1. First, a collection of mutually translated pairs of web pages is provided (302). In some implementations, the collection can include documents other than web pages. A mutually translated pair of web pages is a pair of web pages in which each web page in the pair includes content that can be considered to correspond to a translation of content in the other web page in the pair or a translation of content from a common source web page. For example, a collection of translated pairs of web pages includes multiple web pages containing content in a first language, where one or more of the documents have been translated from a different language. The web pages in the collection are arranged in pairs, where each pair includes a first web page that has been translated (e.g., using a machine translation tool) into the same language as the second web page in the pair and where the first web page includes substantially the same content as the second web page. Given the similarity of features between the documents, the first web page (prior to translation to the same language as the second web page) and the second web page are thus identified as a pair of mutually translated web pages. That is, each web page in a pair can be considered to correspond to a translation of the other web page in the pair. Alternatively, the collection of web pages can include one or more web page pairs, in which each pair includes a first web page in a first language and a second web page in a second different language, each web page containing content that corresponds to a translation of content in the other web page or content in a common source web page. The web pages can be obtained from multiple sources and/or multiple different networks including, for example, news articles, blog posts, and websites, among others. The collection of mutually translated pairs of web pages can be stored in the mutually translated document pair database 140.

Upon obtaining the collection of mutually translated pairs of web pages, the collection is filtered to identify those pairs of web pages that are associated with a particular content sponsor (304), such as an advertiser. For example, in some implementations, an advertiser is associated with a particular domain. The collection of mutually translated pairs of web pages then is filtered to remove all web pages that are not available or present on the specified domain. For example, any web pages not included under the domain www.example_domain.com would be filtered out of the search. In some implementations, a content sponsor is associated with more than one domain. In those cases, the collection of mutually translated pairs may be filtered to include just pairs of mutually translated web pages across multiple specified domains. For example, the collection of a pair of mutually translated web pages may include a first web page associated with an advertiser, where the first web page resides on a German domain (e.g., www.example_domain.de), and a second web page associated with the advertiser, where the second web page corresponds to an English translation of the first web page and resides on a Canadian domain (e.g., www. example_domain.ca). In some implementations, the collection of mutually translated pairs may be filtered to also include those mutually translated web pages that differ in more than the top level domain. For example, a pair of mutually translated web pages may include a first web page associated with a first domain (e.g., www.example_domain.com) and a second corresponding translated web page associated with a second different domain (e.g., www.example_domain2.com) where both the first and second domain are associated with the same content sponsor.

In some implementations, filtering does not need to be restricted by domain. Rather, in some implementations, any level of a uniform resource locator (URL) address can be used to identify pairs of mutually translated web pages associated with the path specified by the URL address. For example, the collection of documents can be filtered to identify all web pages within the collection that are available under a specified path (e.g., http://www.example_domain.com/example_path).

The different domains on which content sponsors are available may not be known. Accordingly, in some implementations, to identify pairs of mutually translated web pages that include desired content, the collection can be filtered based on the content itself instead of the domains associated with the entity. For example, in some implementations, a first web page associated with a sponsor's successful campaign is available in a first language (e.g., English). The sponsor may be interested in expanding the campaign to include landing pages which correspond to versions of the first website, but in one or more different languages. To determine whether the same content already exists in the one or more different languages, the collection of mutually translated web pages is filtered based on a portion or all of the first web page. Such filtering can be achieved using, for example, text based comparisons. Accordingly, translated versions of the first web page containing similar or identical content can be identified.

Once the collection of mutually translated web pages has been obtained, each pair of web pages is analyzed to determine whether the second webpage in the pair (e.g., the translated version of the first web page in the pair) includes a landing page in a specified campaign (306). In some implementations, the content sponsor (e.g., an advertiser) or other user can cross-check the address of the second web page with addresses of links incorporated into one or more advertisements of an advertising campaign. The advertisements and associated address information can be stored, for example, in a database of the content management tool 110. If no match is found, the translated web page does not correspond to a landing page for the content item. If, on the other hand, the address matches an address provided by an advertisement web page, the translated web page is identified as a landing page for that particular content item. In such a case, both documents in the pair correspond to a landing page and the sponsor is already advertising in the translated language. Pairs of mutually translated web pages, in which both documents are landing pages for a specified advertisement, can then be filtered out/discarded from the collection.

Alternatively, or in addition, the content management tool 110 cross-checks the translated web page in a pair with a website that contains landing pages for an AdGroup of an advertising campaign. For example, the content management tool 110 checks to see whether the address of the translated web page is hosted on the domain of the website that contains landing pages for a particular AdGroup of a campaign. If the address is not hosted on the specified website, the translated web page does not correspond to a landing page in the campaign. Conversely, in some implementations, if the address is hosted on the website, the translated web page can be identified as a landing page that is already a part of the campaign. In some instances, however, a translated webpage may be located on a domain that hosts landing pages for an existing campaign, where the translated webpage does not correspond to a landing page. In those situations, the translated webpage can be cross-checked with landing page addresses stored by the content management tool.

Once the collection of mutually translated web pages has been filtered to identify those web pages which are translations and which do not correspond to landing pages, one or more criteria then can be evaluated in order to make a recommendation to an content sponsor or other user for expanding an campaign. In some implementations, the content management tool can identify for the advertiser or other user the number and/or type of distinct languages currently employed by the advertiser in websites but not targeted by the advertiser. For example, for a first web page that corresponds to a landing page in a first language (e.g., English), the content management tool 110 may identify one or more other additional web pages, each of which corresponds to a translation of the first web page in a different language (e.g., Russian, Spanish, Mandarin). The one or more translated versions of the first web page are then evaluated, as explained above, to determine whether they are already a part of a campaign (e.g., if the additional web pages correspond to landing pages in an advertising campaign). If any of the one or more additional web pages is not currently part of a campaign, the content management tool identifies the particular type and/or number of languages for the web pages that are not associated with the campaign.

The languages of web pages that do not correspond to a landing page can be identified to the sponsor or other user in a recommendation. The recommendation can be provided in various forms including, for example, in an oral conversation between an operator of the content management tool and the sponsor or through electronic communication, such as e-mail to the advertiser, in which the e-mail includes information pertaining to suggested languages for expanding a current campaign. Such e-mails can be generated manually by a user or automated by the content management tool.

In some implementations, the criteria that are evaluated to make a recommendation can include criteria related to a performance of the first webpage in a mutually translated pair (e.g., the web page that is currently a landing page for an advertisement). In some implementations, criteria relating to performance of the first web page includes the number of times an address for the first web page has been included/displayed as a link in an advertisement, the number of times a user has selected an advertisement (e.g., clicks) for which the first web page includes a landing page, and/or the number of times a desired transaction (e.g., a sale of a product identified in the advertisement) occurs subsequent to a user selection of an advertisement for which the first web page includes a landing page (e.g., conversion). For example, if the number of conversions for a first web page in a mutually translated pair of web pages (where the first web page includes a landing page for an advertisement and the second web page does not include a landing page) is above a specified amount/threshold, the recommendation may include a suggestion for expanding an advertising campaign to also include the second web page of the mutually translated pair as a landing page for an advertisement.

Performance of the first webpage can be measured based on user interaction data associated with the first webpage. Such user interaction data can include, for example, a number of page views of the first web page. In some implementations, the collection of mutually translated web pages may be filtered based on a minimum number of page views, such that web pages that present information in the first language and that have page views which exceed the minimum number are maintained in the collection. In contrast, other web pages that present information in the first language and which do not exceed the minimum number of page views can be filtered from the collection. Data that is relevant to the performance of the first web page can be stored, for example, in the content database 130.

Alternatively, or in addition, the criteria that are evaluated may relate to the performance a campaign with which the first web page in the mutually translated pair is associated (where the first web page includes a landing page in the campaign). Such criteria can include the number of times a user interacts with a content item in the campaign and/or the number of times a desired transaction occurs subsequent to a user selection of any content item in the campaign. Metrics that can be evaluated to determine the performance of a campaign include, among other things, total revenue associated with the campaign, advertiser revenue, revenue associated with the campaign over a specified period of time, or how often content associated with the campaign is displayed. For example, in some implementations, the collection of mutually translated web pages may be filtered such that web pages which present information in the first language and which are associated with an advertising campaign that exceeds specified revenue over a period of one month are maintained in the collection. In contrast, other web pages that present information in the first language and which are not associated with advertising campaigns that exceed the specified revenue can be filtered from the collection. Other metrics for evaluating the performance of a campaign include number of clicks on an advertisement, cost per click, number of clicks per impressions (e.g., the clicks through rate), the number of conversions and/or the conversion rate, the cost per conversion, a spend versus budget ratio, the number of people reached, the average frequency with which a user sees a particular advertisement, and/or the cost per thousand impressions.

Other metrics for filtering can include, for example, landing page quality, presence or not of an e-commerce cart, whether a website is a secure website (e.g., an https site), the page rank of the website, or whether the website is an analytics enabled website.

In some implementations, recommendations to expand a campaign are restricted to web pages from websites that are sufficiently multi-lingual. That is to say, a content sponsor may have relatively few of its web pages translated into one or more different languages. By restricting the analysis to websites in which a relatively large number of web pages are translated (e.g., sufficiently multi-lingual websites), the quality of the recommendation can be enhanced so as to provide recommendations to content sponsors that are more likely to be interested in expanding their campaigns. In an example, the collection of mutually translated web pages can be further filtered to discard web pages obtained from websites where there is no translation for less than a specified number or percentage of pages in the website (e.g., less than about 80% of the website, less than about 70% of the website, less than about 60% of the website, or less than about 50% of the website). Other percentages may be used instead. In contrast, if the number of web pages that are translated on a specified website exceeds a desired level, the specified website may be identified as sufficiently multi-lingual. Subsequent recommendations for expanding a campaign then can include recommendations to add web pages from the multi-lingual website to the campaign. In some implementations, the collection of mutually translated web pages can be further filtered to discard web pages obtained from multiple different websites associated with a particular entity (or entities) where there is no translation for less than a specified number or percentage of pages across the multiple websites.

Alternatively, or in addition, a recommendation to expand a campaign can be restricted to identifying languages for which a specified quantity (e.g., a minimum number or percentage) of web pages of a website have been translated. For example, in some implementations, a website can include a portion of web pages that are translated into a first language. If the percentage of web pages on the web site translated into the first language is less than a specified amount (e.g., less than about 40%, less than about 30%, less than about 20%, or less than about 10%), the first language is not identified in the recommendation as a language into which the sponsor may wish to expand the campaign. In contrast, if the percentage of web pages on the web site translated into the first language is greater than the specified level, the recommendation may suggest expanding the campaign into the first language. In some implementations, the recommendation can be based on a percentage or number of web pages that are translated into a different language across multiple web sites.

In some implementations, the recommendations can be directed towards currently active sponsors. That is to say, a recommendation to expand a campaign can be limited to web pages of sponsors that are either actively investing in a campaign or have recently been investing in a campaign. Such content sponsors are, in some implementations, more likely to consider expanding a present campaign than those that are not currently devoting resources to a particular campaign. As an example, the collection of mutually translated web pages can be filtered to discard web pages associated with a particular content sponsor (e.g., an advertiser) that has not financed an advertisement over a specified period of time (e.g., no spending on advertisements in at least 1 week, no spending on advertisements in at least 2 weeks, or no spending on advertisements in at least 4 weeks). Web pages associated with content sponsors that have financed an advertisement or advertising campaign within the specified time period, however, may be retained. As previously explained, web pages can be identified as associated with a particular content sponsor based on a web domain or URL, among other techniques of identification. Information as to a content sponsor's spending on one or more campaigns can be contained in the content database 130.

In some implementations, a recommendation to expand a campaign can be limited to web pages based on a level of spending of a sponsor. For example, the collection of mutually translated web pages can be filtered to discard web pages associated with sponsors that have spent less than a specified amount (e.g., less than about $1000, less than about $10,000, or less than about $50,000) on an campaign. The specified amount of spending can be defined for a set period of time (e.g., 1 week, 2 weeks, or 4 weeks). In some implementations, recommendations to expand campaigns can be limited to web pages associated with sponsors that have established multiple campaigns. Sponsors associated multiple campaigns may, in some implementations, have greater resources available for sponsoring content and thus be more inclined to expand current campaigns.

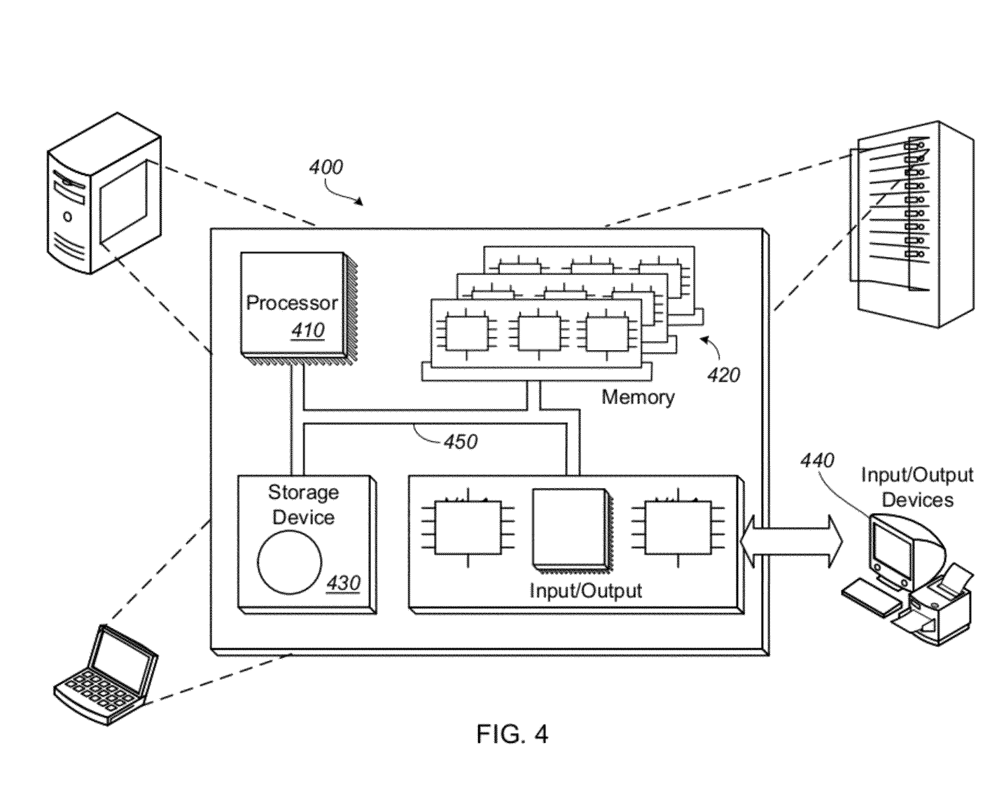

FIG. 4 is a schematic diagram of an example computer tool 400 that can be used for executing the operations and techniques described in this specification including, but not limited to, the techniques 200 and 300 of FIGS. 2 and 3, respectively. The tool 400 can include a processor 410, a memory 420, a storage device 430, and input/output devices 440. Each of the components 410, 420, 430, and 440 are interconnected using a tool bus 450. The processor 410 is capable of processing instructions for execution within the tool 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 includes a computer readable medium such as volatile or non volatile memory that stores information within the tool 400. The storage device 430 is capable of providing persistent storage for the tool 400. The storage device 430 may be a floppy disk device, a hard disk device, an optical disk device, or a tape device, or other suitable persistent storage means. The input/output device 440 provides input/output operations for the tool 400. In one implementation, the input/output device 440 includes a keyboard and/or pointing device. In another implementation, the input/output device 440 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management tool, an operating system, or a combination of one or more of them.

A computer program (also known as a program, software, software application, script, or code) can be written in any form of programming language, including compiled or interpreted languages, and the computer program can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing apparatus that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the apparatus can be interconnected by any form or medium of digital data communication, e.g., a communication network. Examples of communication networks include a local area network (“LAN”) and a wide area network (“WAN”), e.g., the Internet.

The computing apparatus can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosed subject matter or of what may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various apparatus components in the embodiments described above should not be understood as requiring such separation in all embodiments, and it should be understood that the described program components and apparatuses can generally be integrated together in a single software product or packaged into multiple software products.

A number of implementations and embodiments have been described. Nevertheless, it will be understood that various modifications may be made without departing from the spirit and scope of the disclosed subject matter. Other embodiments also are within the scope of the following claims.

What is claimed is:

1. A computer-implemented method comprising:
receiving a collection of webpage pairs, each pair including a first webpage containing common content in a first language and including a second webpage containing the common content in a second different language, at least one webpage in each pair corresponding to a translation from a source webpage;
filtering the collection of webpage pairs to identify one or more pairs associated with a content sponsor;
determining that a first webpage in an identified pair is a landing page for an advertisement associated with an advertising campaign of the content sponsor;
determining that a second webpage in the identified pair is not a landing page in the advertising campaign;
evaluating, using one or more processors, one or more criteria in order to make a recommendation for expanding the advertising campaign to include the second webpage; and
providing the recommendation for expanding the advertising campaign to include the second webpage based at least in part on the evaluating.

2. The computer-implemented method of claim 1, wherein evaluating one or more criteria comprises evaluating a performance of the first webpage.

3. The computer-implemented method of claim 1, wherein evaluating one or more criteria comprises evaluating a performance of the advertising campaign.

4. The computer-implemented method of claim 1, wherein evaluating one or more criteria comprises evaluating a quantity of translated webpages associated with the content sponsor.

5. The computer-implemented method of claim 1, wherein evaluating one or more criteria comprises evaluating a level of advertising financing activity associated with the content sponsor.

6. The computer-implemented method of claim 1, wherein determining that a second webpage in the identified pair is not a landing page in the advertising campaign comprises cross-checking an address of the second webpage with addresses of webpage links incorporated into one or more advertisements of the advertising campaign or cross-checking the second webpage with a website that contains landing pages associated with the advertising campaign.

7. A computer-implemented method comprising:
determining a first webpage includes content in a first language where the first webpage is a landing page associated with an advertising campaign of a content sponsor;
determining a second webpage includes the content in a different second language where the second webpage is not a landing page in the advertising campaign;
evaluating, using one or more processors, one or more criteria in order to make a recommendation for expanding the advertising campaign to include the second webpage; and
identifying a recommendation for expanding the advertising campaign to include the second webpage based at least in part on the evaluating.

8. The method of claim 1, wherein the criteria are selected from the group consisting of criteria related to a performance of the first webpage or the performance of the advertising campaign.

9. The method of claim 1, wherein determining the first and second webpages includes identifying a translated document pair.

10. The method of claim 9, wherein each translated document pair includes a first document containing the content in one language and a second document containing the content in a different language.

11. The method of claim 9, wherein identifying the translated document pair includes filtering a collection of translated documents based on the content to provide the translated document pair.

12. The method of claim 11, wherein filtering the collection of translated documents is further based on one or more domains associated with the content.

13. The method of claim 11, wherein filtering the collection of translated document pairs is based on user interaction data associated with the content.

14. The method of claim 9, wherein identifying the translated document pair comprises filtering a collection of translated document pairs based on a customer identification associated with the content sponsor to provide the translated document.

15. A system comprising:
one or more processors and memory operable to interact to perform operations including:
determining a first webpage that includes content in a first language where the first webpage is a landing page associated with an advertising campaign of a content sponsor;
determining a second webpage that includes the content in a different second language where the second webpage is not a landing page in the advertising campaign;
evaluating, using one or more processors, one or more criteria in order to make a recommendation for expanding the advertising campaign to include the second webpage; and
identifying a recommendation for expanding the advertising campaign to include the second webpage based at least in part on the evaluating.

16. The system of claim 15, wherein the criteria are selected from the group consisting of criteria related to a performance of the first webpage or the performance of the advertising campaign.

17. The system of claim 15, wherein determining the first and second webpages includes identifying a translated document pair.

18. The system of claim 17, wherein each translated document pair includes (1) a first document containing the content in one language and (2) a second document containing the content in a different language.

19. The system of claim 17, wherein identifying the translated document pair includes filtering a collection of translated documents based on the content to provide the translated document pair.

20. The system of claim 19, wherein filtering the collection of translated documents is further based on one or more domains associated with the content.
